(19) United States
(12) Patent Application Publication
(10) Pub. No.: US 2004/0218226 A1
(43) Pub. Date: Nov. 4, 2004

(54) Method and system for sending electronic messages from a fax machine

(76) Inventors: Walter G. Antognini, New York, NY (US); Thomas C. Antognini, Lexington, MA (US)

Correspondence Address: BROWN, RAYSMAN, MILLSTEIN, FELDER & STEINER LLP, 900 THIRD AVENUE, NEW YORK, NY, 10022, US

(21) Appl. No.: 10/298,474

(22) Filed: Nov. 18, 2002

Related U.S. Application Data
(63) Continuation of application No. 09/598,185, filed on Jun. 21, 2000, now abandoned.

(51) Int. Cl. G06F 15/00; H04N 1/00

(52) U.S. Cl. 358/402; 358/1.15

(57) ABSTRACT

The system and method of the present invention presents a process for transmitting an electronic message that comprises printing a first document with machine-readable code which contains data corresponding to an electronic address of an intended recipient and transmitting the first document from a facsimile machine to a computerized device configured to receive facsimiles. The machine-readable code is decoded upon receipt by the computerized device to retrieve the data corresponding to the electronic address and an electronic message addressed to the electronic address is generated. The electronic message is then transmitted to the electronic address of the intended recipient.

This is a continuation application of application Ser. No. 09/598,185 filed Jun. 21, 2000, now pending. application Ser. No. 09/598,185 is hereby incorporated herein by reference into this application in its entirety.

### RELATED APPLICATIONS

This application is related to application Ser. No. 08/605,549, filed Mar. 1, 1996, titled “Variable Formatting of Digital Data into a Pattern,” which is hereby incorporated by reference into this application in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention disclosed herein relates generally to telecommunications using facsimile machines and, more particularly, to improved methods and systems for utilizing facsimile machines to send electronic messages such as by e-mail.

Fax cover sheets are commonplace documents generated to identify the recipient of the fax, the recipient's fax number, and information identifying the sender. Particularly in the corporate setting, it is common practice for workers to generate a cover page on their PC for a fax. For one thing, a cover page generated from a PC can be made to conform to a corporate standard format. It is also machine printed, engendering a presentable and professional appearance. In some cases, the contact information for recipients is stored on a PC, and is most naturally retrieved in that context. Often, a cover page module fills in the sender personal contact information automatically, the user pulls the fax numbers and other address information for the recipient from a PC based directory, and the user adds comments to the page to explain the content of the fax.

Faxing from a fax machine leaves little opportunity for creative Internet services. A fax generated from a standard fax machine comes into a fax server essentially only with its banner information, the phone number to which it was sent, and the document images themselves. While optical character recognition or OCR can be used to recover some information from the document images, this information is typically incomplete and unreliable, due to the relatively poor image quality of a faxed document.

U.S. Pat. Nos. 6,025,931 and 6,023,345 issued to Bloomfield and titled “Facsimile to E-Mail Communication System with Local Interface,” both of which are hereby incorporated into this application in their entirety, describe a system for sending a hardcopy document via a fax device to a recipient via electronic mail. As described in the patents, the e-mail addresses of desired recipients are input by senders through a telephone keypad on the fax machine and are saved in memory for later reference and selection by senders. A faxed document is converted to a file which is sent as an e-mail to the recipient whose e-mail address was input or retrieved from storage based on the sender's selection. This system provides only limited and inflexible fax to e-mail options, requires the sender to enter and store e-mail address in specific fax machines or systems, and fails to provide an expansive range of Internet services.

There is thus a need for improved techniques for using fax machines and technology to support a variety of advanced services such as Internet communications.

### BRIEF SUMMARY OF THE INVENTION

It is an object of the present invention to provide improved techniques for using fax machines to send electronic messages to various network devices and recipients.

The above and other objects are achieved by a method for transmitting an electronic message using a fax machine. The method includes printing a first document with machine-readable code which contains data corresponding to an electronic address of an intended recipient, and transmitting the first document from a facsimile machine to a computerized device configured to receive facsimiles. At the computerized device, which may be a fax server accessible via a local phone number over the PSTN, the method further includes decoding the machine-readable code received to retrieve the data corresponding to the electronic address, generating an electronic message addressed to the electronic address, and transmitting the electronic message to the electronic address of the intended recipient.

The present invention represents a powerful and general mechanism that can enable a variety of Internet services relating to fax. In particular, it can generate special cover pages for faxes, usable at a fax machine, with powerful capabilities. These cover pages can support among other things the ability to:

fax from any fax machine to any e-mail address (not simply to those e-mail addresses already associated with an assigned phone number), and to any IP address for a network connected printing peripheral;

employ a local number when sending a fax to an e-mail (or IP) address, or to a non-local fax number;

broadcast a fax to any number of ordinary fax phone numbers, e-mail addresses, and IP addresses;

forward, to one's own e-mail (or web) account, copies of any fax one sends from a fax machine, thus archiving the fax, and helping to consolidate outgoing messages in one box;

send specific e-mail text and attachments to be associated with the fax when it arrives in an e-mail account; and

process a stack of fax jobs with a single speed dial operation.

The identified applications expand the use of Internet fax services by allowing such services to be utilized by a broader range of people, in many more situations, with much greater ease of use, and at far less expense. The consequent growth in consumer use, and market size, can enable Internet fax service providers to become even more prominent players in the new economy.

The approach described herein of encoding information into cover pages fits seamlessly into the current practices of great many users of fax machines, as described above. All the information available in typical PC generated cover sheets and supporting data files may be encoded in digital form on the cover page.

In accordance with some embodiments, a local fax server number may be programmed into a fax machine in its speed dial function, and always invoked when an encoded cover page is utilized. By encoding all relevant digital information on the cover page, any information and selections generated at the PC should come through perfectly, and without further user entry at the fax machine. The display and context of the PC makes this by far the most familiar, comfortable, capable, and convenient station at which to make the decisions about the routing and handling of the faxed document.

To utilize the techniques described herein, a user may first download software designed to print a variety of encoded cover pages to be prepended to fax jobs. This software would allow the user to generate the cover pages fully off-line, providing the greatest possible convenience. For example, the user could compose them on a laptop then directly print them out, without any need to establish an on-line connection. For many purposes, the user, and often colleagues, will be able to reuse the cover pages any number of times.

By encoding an e-mail address in a machine-readable code, the fax can be forwarded to the address even though no phone number is associated with that address, as would be required by many current fax to e-mail services. The fax server can simply forward it to the encoded address. Likewise, by encoding a fax number, the fax may be forwarded to that fax number. This allows one to place a local call to connect to the fax server, and have the fax routed to an e-mail address or to a desired non-local fax number. The mechanism whereby the fax is communicated to a non-local number may of course be made far less expensive than the usual toll call. Forwarding to an e-mail address similarly can employ a local number for the fax server.

Increasingly so into the future, many printers and fax machines will be directly connected to the Internet, and will possess their own IP addresses. These IP addresses can also be encoded on a cover page so that the faxed document can be directly forwarded to the printing peripheral. Broadcast fax is also easily enabled. The pattern can encode a large list of phone numbers, and/or e-mail addresses, and/or IP addresses.

The cover page could, perhaps routinely, encode one's own e-mail or web account, so that an archived copy of outgoing faxes from a fax machine could be forwarded to one's account. This would allow users to record what they have faxed, to whom, and when. If the same fax must be sent to the same person or another at some later date, it would now exist in ready form in one's account. If a confirmation of receipt of the fax is desired, then the message sent to one's account can report when the fax did get through to the various parties to whom it was sent. Alternatively or additionally, at the user's option, this confirming information could be sent via fax-back to the very fax machine that sent out the fax.

In all of the cases above, the cover page, once generated, can be used again and again, in order to achieve the same effect. Among the advantages behind the use of cover sheets in accordance with the present invention is that the capabilities they are not tied to a particular fax machine. While a given fax machine may be preprogrammed to perform fairly complex and customized functions with a couple of button pushes, the cover sheets can enable similarly complex, yet easy to perform, faxing at any fax machine. This would be particularly useful for business people on the road, who might come prepared with a number of cover pages they might expect to use. Moreover, the cover sheets might be transferred to others so that a fax can be easily, inexpensively, and accurately launched to the appropriate parties.

One might naturally keep a set of cover sheets encoded to send to one's own fax number, which can be given to others to enable inexpensive faxing via a local server number to one's own fax account. Such a cover sheet might also be used to trigger a specific fax-back, containing, say, product information. This would obviate the need for the usual fairly complex button entry for fax-backs, which for many people is a significant deterrent to its use.

The cover sheets could also simplify operation of a given fax machine as well. The number for a local fax server could be preprogrammed into a speed dial operation, and always utilized whenever a cover sheet is used. Indeed, a number of fax jobs can be handled at once in the same way. One could put an encoded cover page on each fax job, stack the jobs together, insert the stack into the fax machine document feeder, perform once the simple speed dial operation, and walk away. This would eliminate the need to baby-sit all of the jobs through, since otherwise each would require a different number to be entered.

An additional feature of the present invention is to employ the cover pages to provide more useful e-mail messages associated with the fax file sent to an e-mail account. Suppose for example that a fax is sent from a hotel fax machine. In that instance, unlike the usual case with e-mail, the generated e-mail text would provide no information even about the real identity of the sender of the fax, nor would the subject line identify easily and quickly the content or priority in handling of the fax. This limitation detracts from the appeal of fax to e-mail services. It creates a conceptual gap between standard e-mail messages on the one hand and e-mail messages with fax attachments on the other, making their integration strained and unnatural.

By encoding the content of the e-mail to be sent on a cover page, this limitation can be removed. At minimum, the cover page can always be encoded to include the identity of the sender, so that even from a hotel fax it will be known who sent it. It would also be possible to create specific cover pages with distinct subject lines. And it would be quite easy, and often very useful, to compose an e-mail specifically for a given fax, to explain the content of the fax, or provide other ancillary information about it. A number of services now exist that provide voice mail acknowledgment of receipt of a fax; the content of those messages can be made as descriptive as desired via an encoded cover page, and text-to-speech synthesis. Indeed the cover page might encode a short true audio voice message, by using voice compression techniques.

Many handheld devices, from pagers to PDAs and cell phones, are able to receive text messages from e-mail. For these cases, it will be important to allow substantial textual content in the body of an e-mail with a scanned document attachment, since the devices cannot conveniently display any commentary printed in the scanned document itself. From the standpoint of knowledge management as well, it is important to have as much of the commentary as is possible to be in a digital form, since that is the only manner in which filtering, sorting, data mining, etc., can readily be achieved.

In general, the technology described herein enables authentically hybrid messages. At this time, many messages are pigeonholed into either scanned documents (usually in the form of a fax) or e-mail. Clearly, however, there is a large class of messages whose natural expression would be a combination of both. Consider for example a case in which a contract is in dispute. It would be quite natural to fax the relevant pages, perhaps with signatures and markups, but also to add commentary about the issues in ordinary text. It is most natural to add the textual commentary in the body of an e-mail; this is indeed the standard role e-mail plays. Of course, the digital information so generated would support the many benefits explained herein.

It would also be possible to include further attachments to a fax to e-mail message, by encoding the attachments in the cover page as well. Some users might wish to attach certain files fairly routinely, much as they do already with ordinary e-mail, such as a vcard, which contains business card information, or a logo which always appears in the e-mail.

The encoded cover pages can be designed to facilitate their easy and frequent use. They would provide in human readable text clear explanations of how to use them and of what the precise effect of their use would be. In essence, the cover sheet becomes the user interface to the fax machine, supplanting the complex and idiosyncratic sequence of button pushes otherwise required. Thus, the cover sheet would include in readable text appropriate fax server numbers to dial up, the list of fax numbers and e-mail addresses to which the fax will be sent, a notice about whether transmission confirmation will be sent, and a description of the information that will be included in the e-mail message if it is sent to an e-mail address. These cover pages might typically be read, decoded, and acted upon only by the fax server, and would not be included in the fax forwarded to the final recipients.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram of a system for sending electronic messages from a facsimile machine in accordance with one preferred embodiment of the present invention; and

FIG. 2 is a flow chart showing a process of sending electronic messages from a facsimile machine in accordance with one preferred embodiment of the present invention.

### DETAILED DESCRIPTION OF THE PREFERRED EMBODIMENTS

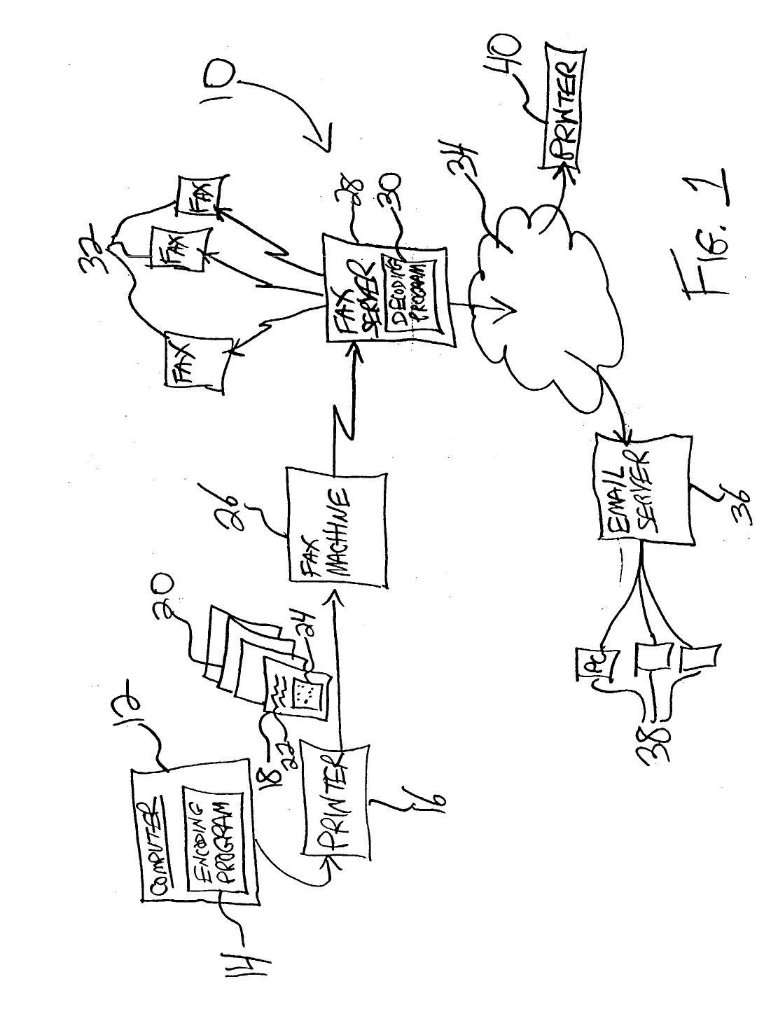

With reference to FIG. 1, one preferred embodiment of the invention is a system 10 for implementing improved techniques for fax to email and other electronic messaging services. In its broadest sense, the system 10 includes a computer 12 used by a sender of the fax and running an encoding program 14 for generating machine-readable code from a data set. In one embodiment, the encoding program is the PAPERDISK software program available from Cobblestone Software of Lexington, Mass. As used herein, the machine-readable code of one embodiment is a two-dimensional code referred to as a datatile. The PAPERDISK program provides the option to format for various types of fax resolutions (e.g., standard, fine, superfine) so as to increase data density in the datatile. The technology underlying the PAPERDISK program is described in the above mentioned application Ser. No. 08/609,549. As one skilled in the art will recognize, any suitable encoding program may be used.

The system 10 further includes a printer 16 coupled to the computer 12 for printing documents 18 and 20, including a document 18 containing a datatile 24. When that document 18 is a fax cover sheet, it may also contain text information 22 listing the fax number of the receiving fax machine or other information relating to the transmission of the fax and which instructs the sender how to send the fax.

As explained further herein, the datatile 24 contains data corresponding to an electronic address(es), such as an email address(es), of the intended recipient(s) of the converted fax. The datatile produced by the encoding program may also contain an e-mail subject, e-mail message (which could include hyperlinks within the message or to other message files or to other files), plus attachments. The encoding program 14 has in one embodiment a user interface similar to an email composition screen display, and converts the input data into the datatile. The encoding program may also provide the option to “hide” text in a datatile until decoded so as to free up more space on the cover sheet, for example, by hiding text that will be printed in the cover sheet as a message after a datatile is decoded and removed, as discussed further below. For appropriate circumstances (e.g., for client billing purposes when used on internal fax server), the datatile can also include an account number or serial number. The encoding program could further provide advertising on the fax cover sheet that stays constant until, e.g., an update of the software. The system 10 may then track the number of times a given person or account faxes, and the person could be charged advertising per use. Advertising may be changed on upgrades of the encoding program, and the serial number used in faxing could include ad number.

In one alternative embodiment, an XML or comparable format file is produced that contains everything needed for an e-mail message except the attachments (e.g., recipient's e-mail address, text of e-mail message, return e-mail address, cc and bcc addresses including instructions for sending a copy to internal files), and the encoding program 14 includes in the datatile that XML file with all files that are attachments.

In another embodiment, the user may choose to include only the location (URL) of the files that the user wishes to send, instead of the files themselves. This might be particularly warranted if the files are large and would not easily fit within a datatile that can be faxed. The file could be in a database, on the Internet, within an intranet or otherwise available online (LAN, WAN, SAN, etc.) or could be made available through request (e.g., the datatile might contain a request to have someone physically load a digital media or a media which could be made digital, such as microfilm loaded on a computer/scanner combination capable of scanning microfilm and making it digital, which would make the file available). The file is preferably available both at the computer producing the datatile (so that the address is readily available) and at the fax server.

The printed documents 18 and 20 are transmitted over a conventional fax machine 26. The fax machine is preferably set to call a local or toll-free number to a fax server 28. The fax server may have a single telephone number but has multiple telephone ports and is capable of handling multiple simultaneous calls. The fax server 28 receives the fax in accordance with technology known to those of skill in the art.

In accordance with the invention, the fax server 28 contains or is associated with a decoding program 30 for decoding the data contained in the datatile 24 received with the fax. In some embodiments, the decoding program 30 is the PAPERDISK program described above, although other programs may be used depending upon the encoding programs used in the system 10. In accordance with processes described in greater detail below, the decoding program 30 detects and decodes the data tile 24 and retrieves the data contained therein. The data is then used to generate and send electronic messages to intended recipients, including as appropriate fax machines 32, or, via network 34 such as the Internet, email server 36 for forwarding to personal computers 38 or an IP printer 40.

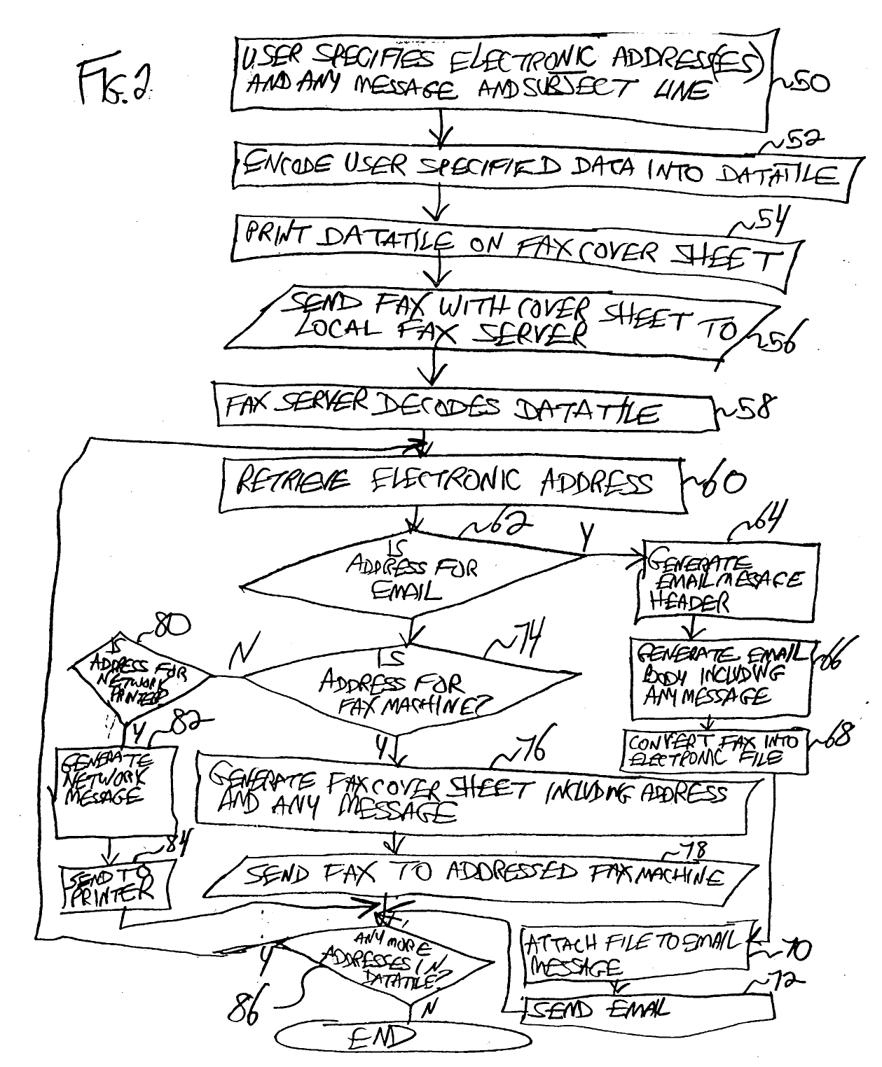

Referring now to FIG. 2, a process of one embodiment of the present invention using system 10 begins when a user specifies to the computer running the encoding program one or more electronic addresses, any message desired to be sent with the electronic message, and any subject line for the message, step 50. The encoding program encodes the specified data into a datatile, step 52, and sends the fax cover sheet and datatile to the printer for printing, step 54. The sender transmits the fax cover sheet and associated document to be faxed to the fax server, which is preferably a local server accessible through a local telephone number, step 56.

The fax server receives the fax cover sheet and fax, decodes the datatile, step 58, and retrieves the electronic addresses and other data, step 60. In some embodiments, the decoding program first removes the datatile from the fax cover sheet. The process of removing the datatile is performed as follows. The image of the cover page is captured and segregated from the remainder of the fax image pages. The boundaries of the datatile(s) are determined, e.g., by coordinates of first landmark and coordinates of lower right marker, plus a few pixels (e.g., twice the number of pixels as the marker is high). The datatile is removed by reassigning another image in the space designated by the datatile's coordinates, where that other image could be blank pixels or a blank image. An image or text contained in and designated by the datatile itself may include advertising or the logo of the sending or transmitting company. As explained above, the datatile may contain additional comments about the fax because there is not enough space for the comments—taking away the datatile frees up some space on the cover page that is transmitted to the recipient. A different cover page is produced for each recipient—e.g., a cover page customized for each recipient that contains only their name, address and other identifying information.

In alternative embodiments, the decoding program produces an entirely different cover page from the data provided in the datatile—e.g., the data in the datatile allows the fax server to reproduce a cover page that does not have the imperfections introduced by the relatively imprecise scanning processes of a fax machine. The cover page with the datatile is removed entirely, which may be especially appropriate where a fax transmission has two cover pages—one with the datatile, and a normal cover page.

The decoding program then analyzes each of the data sets corresponding to electronic addresses in the datatile. For an address which represents an email address, step 62, the decoding program generates the email message header using the retrieved address and subject line, if any, step 64, generates an email body containing the message, if any, contained in the datatile, step 66, and converts the faxed document to an electronic file in any of a number of standard image or graphics file formats, step 68. The converted file is attached to the email message, step 70, and the fax server then sends the email message, step 72, over a network connection.

In some embodiments, this process of generating an email is performed as follows. The decoding software parses decoded data into basic components:

e-mail address(es)

subject line

e-mail message

attachment(s) (i.e., files)

URLs and other addresses to files which will be attached

account/serial numbers

The software creates the following basic components of an e-mail message from the decoded datatile:

To:

From:

Subject:

Body of e-mail

The body might also consist of or include automatically generated text. The software attachments include the faxed images themselves (i.e., the reconstructed fax file), attached files (the fax server accesses those files for which only a location is provided in the decoded datatile—files included in their entirety in the datatile would be available by virtue of the fax server having decoded the datatile), and advertising files (which could include logos as hyperlinks and could be automatically invoked by viewer software).

When the recipient receives the email message, the attachments are available consistent with current practices for accessing attachments, including the option for first scanning the attachments for viruses before opening. The attachment is invoked when the recipient double-clicks on the file (e.g., in Windows Explorer) or when it is run in an application. The application running the attachment presents an initial screen with advertisements and instructions to click to continue. When the recipient clicks, an image of the fax is displayed and the application allows some basic other capabilities, including printing, saving, navigating around the document, zooming, closing, etc.

Returning to FIG. 2, if the address is for a fax machine, step 74, the decoding software generates a fax cover sheet including the address and any message contained in the datatile, step 76. The fax is then sent to the fax machine, such as over the PSTN, step 78. In an alternative embodiment, for attached files, the decoding program (which includes in this embodiment encoding capabilities) creates a separate datatile of files if sender chooses to have files sent as a datatile, and/or creates an e-mail message with attachments if the sender chooses to have files sent electronically. The decoding program creates an image file of the document to be sent plus the attachments datatile, if any. The fax server transmits the image file over the Internet to a fax gateway, and transmits the e-mail message, if any, with attachments. At the fax gateway, if the e-mail was sent in the first step, an image of the e-mail is generated and an image of a datatile for the attached files is generated and appended to the email. At the fax gateway, a local phone call is initiated and the generated images are transmitted to the fax machine. The fax machine receives the fax transmission and prints the image, or stores and/or forwards if received by fax modem, including by a fax server.

If the address is for a network connected printer, step 80, a network message is generated, step 82, and sent to the printer, step 84. In one embodiment, the decoding software (which in this embodiment includes encoding capabilities) generates a separate datatile of files fdor each attachment if the sender chooses to have files sent as a datatile, and/or generates an e-mail message with attachments if the sender chooses to have files sent electronically. The decoding program creates an image file of the document to be sent plus attachments datatile, if any, and transmits the image file over the Internet. It further transmits the e-mail message (if any) with attachments. The IP-enabled printer receives the transmission over the Internet. If an e-mail message was sent, the IP-enabled printer first creates an image of the e-mail and creates and appends an image of a datatile containing attached files. The IP-enabled printer prints the received image. If the IP-enabled printer contains or is connected to a storage device, the image and/or any attached files may also be stored.

These processes of generating electronic messages are repeated for each separate address in the datatile, step 86. As is now clear, this system and method provides great flexibility in the sender specifying any number of email addresses, fax machines, and printers in one fax cover sheet. The sender may also include the sender's own email address, which would result in the sender receiving a confirmation copy of the fax for long term storage on the sender's email system. In some embodiments, the sender may automatically or upon clicking or otherwise acting on the confirmation email, store the fax attachment in a predesigned fashion, such as when the e-mail is sent back to the sender himself, the fax could be stored in an email customer folder and matter file designated in the datatile.

One skilled in the art will recognize many variations and additional functions which could be performed using the basic method and system described herein. For example, the system could support the ability for the recipient (which may be the sender himself) to automatically, or automatically after clicking, act on data contained in a datatile(s) contained in the fax (e.g., a datatile(s) in addition to cover sheet datatile). If the datatile contains an application, the recipient may run the application. If the datatile contains a file associated with an application (e.g., an Excel spreadsheet), activation of the may launch the application and load the file. If the datatile contains data, activation of the attachment stores the data, e.g., in a place designated in the datatiles.

The system further supports the ability to have standard types of data (e.g., V-card or similar data) provided in datatiles (e.g., in cover page datatile) and to act on these data types in standard (by default) fashions. For example, V-card type data would be stored in a database with other V-card type data (unless the data is already there).

In addition, the system and datatiles may be used to support and enable e-commerce solutions, such as encoding catalog information, personal commerce data (e.g., name, address, credit card and number, phone number, e-mail address, etc., of customer), a digital check, or registration information.

As yet another application of the present system and method, instructions may be encoded into the datatile that would automatically send a notification of fax to the recipient's pager and/or cell-phone (the data sent could also include other capabilities, such as a voice recording, or a text-to-speech playout, or text that could be converted text-to-speech). The system may further enable knowledge management and data mining capabilities, by, in general, adding the ability to sort, sift and organize the information contained in faxes so as to allow integration with large corporate knowledge infrastructures.

While the discussion thus far focuses on the possibilities of transmitting from a fax device to e-mail of from a fax device to another fax device through the Internet, the invention should be understood as contemplating other fax device to Internet applications. One such application would transmit data from a fax device to a website or intranet or other network location.

A fax cover sheet could be prepared, where that fax cover sheet contains sufficient human readable information to indicate the action that an ensuing fax transmission would enable. The cover sheet would also include a telephone number of a fax server to receive the fax transmission, where that number is preferably a local number thereby avoiding long distance charges to the sender or toll charges to the recipient. That fax cover sheet would also contain machine readable code containing data that includes a website URL or potential URL and could also include the name, address, telephone number, and fax number of the person posting the document, and if the person posting the document is an enterprise, the enterprise type. That fax cover sheet is transmitted to the potential candidate, with the transmission occurring by mail, hand delivery, fax transmission, e-mail or any other method for the transmission of documents.

The person desiring to post a document to the website or other network location then attaches to the fax cover sheet any documents that that person desires to have available to those having access to the network location. Such documents could include, for example, a listing of the hours the establishment is open, a price list, in the case of a restaurant, a menu, the names of the owner and/or employees with any phone extensions, physical address with directions, and any other information that the establishment makes available to the public through printed documents.

While the discussion thus far assumes that the person posting documents would fax in documents, some or all such documents could of course be scanned using a device that scans with better results (e.g., at a higher resolution, or with more information per pixel such grayscale or color), and the scanned documents could be transmitted, either by facsimile protocols or otherwise. This possibility is especially important in the context of multifunction machines that can scan, print and fax. Such machines could scan in documents at a higher resolution and/or in color, and then transmit those images to the server, either to the fax server or the web server of the present invention. The images produced by scanning with devices other than traditional fax machines have the advantages of improved esthetic appearance and improved machine recognition (through OCR, ICR, etc., as previously discussed).

The process could be used to create an entire website, or part of a website. The process would preferably use a website URL contained within and derived from the machine-readable code on the fax cover sheet. If the URL for the website involves a new top level domain name (e.g., “www.mybakedgoods.com”), the process would automatically reserve the name with an organization that assigns domain names. If the URL is for a website within an aggregation of websites (e.g., “www.mybakedgoods.centralestore.com”), the process would create a new entry on the web server of that aggregator using the URL as the website name within the aggregation of websites. The process would also create a home web page for the new website. The home web page would contain the name, address, telephone number, fax number, and type of enterprise, organization or person of the client. The home web page would also contain links to the image files of the documents attached to the cover sheet by the client. While in the preferred embodiment the document images are separate pages linked to the home page, in other embodiments, the document images are made part of the home page and the links are therefore to locations on that home page.

For example, a restaurant might have a general fax cover sheet with machine-readable code providing general details for the website (e.g., name, address, telephone number, fax number, and type of enterprise) and attached to that cover sheet, in the following order, a second cover sheet with machine-readable code indicating that the document that follows is a menu, then three pages of a menu, then a third cover sheet with machine-readable code indicating that the document that follows provides delivery information, then 1 page of delivery information, then a fourth cover sheet with machine-readable code indicating that the document that follows provides directions on getting to the restaurant, then two pages of directions. The process would create (or modify) a website based on the fax transmission. The website would have a home page designed by following the instructions provided in the general cover sheet, with links to a menu, delivery information, and directions.

While the process above is described primarily in the context of creating Internet websites, it should be understood that the process could be used to good effect for other purposes. One such use is for creating or adding to an intranet or extranet. An organization's human resources department, for example, could use the process to post new reimbursement policies on the company's intranet by attaching the cover sheet of the invention to the front of a printed document indicating the new policies and then faxing the combined document to a fax server which decodes the information and forwards the document image to a server maintaining the intranet so that the organization's employees have access to the document image. In a university setting, for example, the invention could be used to place the syllabus for each course on the school's intranet (or extranet or Internet website) by creating a cover sheet for each course taught, sending that cover sheet to the faculty member teaching the course or to a representative of the department responsible for the course, and instructing the faculty member or department representative to attach the course syllabus to the cover sheet and fax it in to the fax server of the invention.

In one embodiment, large numbers of cover sheets are prepared, where each cover sheet contains a unique URL as human-readable text on the cover sheet as well as in the machine-readable code placed on the cover sheet. For example, an organization maintaining a website, www.faxesforever.org, might desire to give its employees the ability to post documents to its website. The organization could produce a series of cover sheets each containing a distinct URL, such as www.faxesforever.org/abcd1, www.faxesforever.org/abcd2, www.faxesforever.org/abcd3, etc. The organization could then distribute these cover sheets to its employees. If the employee desired to post information about, for example, an upcoming meeting of a committee, the employee could prepend one of the cover sheets received to a document or to machine-readable code containing a file of the information, and then transmit the combined document. The employee would know how to refer others to the document because the URL would be printed on the cover sheet.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A method for transmitting an electronic message, the method comprising:
printing a first document with machine-readable code which contains data corresponding to an electronic address of an intended recipient;
transmitting the first document from a facsimile machine to a computerized device configured to receive facsimiles;
decoding the machine-readable code received by the computerized device to retrieve the data corresponding to the electronic address;
generating an electronic message addressed to the electronic address; and
transmitting the electronic message to the electronic address of the intended recipient.

2. The method of claim 1, comprising transmitting with the first document a content document containing text or image data and wherein the step of generating the electronic message comprises generating the message containing all or part of the data from the content document.

3. The method of claim 2, wherein the step of generating the electronic message comprises converting the content document into an electronic file and attaching the electronic file to the electronic message.

4. The method of claim 1, wherein the step of printing the first document comprises printing the first document having machine readable code which further contains a text-based message, and wherein the step of generating an electronic message comprises generating the electronic message to include all or part of the text-based message.

5. The method of claim 1, wherein the step of printing the first document comprises printing the first document having machine readable code which further contains a subject line, and wherein the step of generating an electronic message comprises generating the electronic message to include the subject line.

6. The method of claim 1, wherein the step of printing the first document comprises printing the first document having machine readable code which contains data corresponding to a plurality of electronic addresses of a plurality of intended recipients, and wherein the step of generating the electronic message comprises generating a plurality of electronic messages addressed to all or some of the electronic addresses.

7. The method of claim 6, comprising transmitting with the first document a content document containing text or image data and wherein the step of generating the electronic messages comprises generating the electronic messages each containing all or part of the data from the content document.

8. The method of claim 6, wherein the step of printing the first document comprises printing the first document having machine readable code which further contains a text-based message, and wherein the step of generating the electronic messages comprises generating each electronic message to include all or part of the text-based message.

9. The method of claim 1, wherein the electronic address comprises an electronic mail address, wherein the step of generating the electronic message comprises generating an electronic mail message, and wherein the step of transmitting the electronic mail message comprises transmitting the message over a network.

10. The method of claim 1, wherein the electronic address comprises an address for a facsimile machine, wherein the step of generating the electronic message comprises generating an facsimile message, and wherein the step of transmitting the message comprises transmitting the message to the facsimile machine.

11. The method of claim 1, wherein the electronic address comprises a network address for a peripheral device connected to the network, and wherein the step of transmitting the message comprises transmitting the message to the peripheral device over a network.

12. A method for generating a fax cover sheet comprising:
allowing a user to specify one or more electronic addresses of intended recipients of an electronic message generated based on a fax;
encoding data corresponding to the one or more specified electronic addresses in a machine-readable code; and
printing the fax cover sheet containing the encoded machine-readable code.

13. A method performed in a fax server for converting a fax into an electronic message suitable for transmission, the method comprising:
receiving from a remote fax machine a fax document, at least one sheet of the fax document containing a machine-readable code;
decoding the machine-readable code to retrieve an electronic address encoded within the machine-readable code; and
generating an electronic message addressed to the retrieved electronic address.

14. The method of claim 13, comprising receiving a content document with the fax document, the content document containing text or image data, and wherein the step of generating the electronic message comprises generating the message containing all or part of the data from the content document.

15. The method of claim 14, wherein the step of generating the electronic message comprises converting the content document into an electronic file and attaching the electronic file to the electronic message.

16. The method of claim 13, comprising decoding the machine-readable code to further retrieve a text-based message encoded within the machine-readable code, and generating the electronic message to include the text-based message.

17. A method for a sender to retain an electronic record of a faxed document, the method comprising:
printing a first document with machine-readable code which contains data corresponding to an electronic mail address of the sender;
transmitting the first document with the faxed document from a facsimile machine to a computerized device configured to receive facsimiles;
decoding the machine-readable code received by the computerized device to retrieve the data corresponding to the electronic address;
generating an electronic message addressed to the electronic address; and
transmitting the electronic message to the sender's electronic address.

18. The method of claim 17, wherein the step of generating the electronic message comprises generating an electronic version of the faxed document and including the electronic version of the faxed document in the electronic message.

19. A fax cover sheet comprising a machine-readable code which contains data corresponding to an electronic address of an intended recipient, the machine-readable code being decodable for retrieval of the electronic address and generation of an electronic message addressed to the electronic address.
